(19) United States
(12) Patent Application Publication
(10) Pub. No.: US 2025/0077602 A1
(43) Pub. Date: Mar. 6, 2025

(54) SYSTEM AND METHOD FOR GENERATING, VISUALIZING SEQUENCE OF DATA QUERIES ACROSS MULTI-CLOUD STORAGE SYSTEMS AND DATABASES

(71) Applicant: Dojoit, Inc., San Jose, CA (US)

(72) Inventor: Tawhid Khan, San Jose, CA (US)

(21) Appl. No.: 18/819,626

(22) Filed: Aug. 29, 2024

Related U.S. Application Data
(60) Provisional application No. 63/535,481, filed on Aug. 30, 2023.

(51) Int. Cl. G06F 16/9538; G06F 16/9535

(52) U.S. Cl. CPC G06F 16/9538; G06F 16/9535

(57) ABSTRACT

A method and system for handling a user query are provided. The method includes setting up a symbol or link in a user interface, the symbol or link representing a dataset in a cloud environment, receiving a user query initiated by a user through the user interface, parsing the dataset to identify a data file associated with the user query, generating a sequence of queries based on the user query and content parsed from the data file, and searching against the data file using the sequence of queries to obtain a set of query results.

### CROSS-REFERENCE TO RELATED APPLICATION

The application claims priority of U.S. provisional application No. 63/535,481 filed Aug. 30, 2023, which is hereby incorporated by reference in its entirety.

### TECHNICAL FIELD

The present disclosure relates to data queries in multi-storage systems, and in particular to systems and methods for generating and visualizing sequences of data queries extracted from multi-cloud storage systems and databases, analyzing the queries using machine language models, and displaying results in a visually appealing and understandable manner.

### BACKGROUND

Data is often stored across various storage systems and databases within a cloud environment. Extracting valuable insights from dispersed data subjects across multiple storage systems in a cloud environment faces diverse challenges including retrieval, analysis, and visualization. Conventional user query and data extraction applications fall short in offering intuitive query generation, efficient data extraction, and visually appealing results.

### SUMMARY

To address the aforementioned shortcomings, a method and system for handling a user query are provided. The method includes setting up a symbol or link in a user interface, the symbol or link representing a dataset in a cloud environment, receiving a user query initiated by a user through the user interface, parsing the dataset to identify a data file associated with the user query, generating a sequence of queries based on the user query and content parsed from the data file, and searching against the data file using the sequence of queries to obtain a set of query results.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accordance with the present teachings, by way of example only, not by way of limitation. In the figures, like reference numerals refer to the same or similar elements. Furthermore, it should be understood that the drawings are not necessarily to scale.

FIG. 1 illustrates a block diagram of an example query generation and result rendering system, in accordance with an embodiment of the disclosure.

FIG. 2 illustrates a block diagram of example modules included in a query generation and result rendering application, in accordance with an embodiment of the disclosure.

FIG. 3 illustrates an example user interface for setting up a connection for a dataset and for receiving a user query, in accordance with an embodiment of the disclosure.

FIG. 4 illustrates an example visualization of query results from a sequence of generated queries, in accordance with an embodiment of the disclosure.

FIG. 5 illustrates an example outcome of SWOT analysis of query results, in accordance with an embodiment of the disclosure.

FIG. 6 illustrates a flow chart of an example method for handling a user query, in accordance with an embodiment of the disclosure.

FIG. 7 illustrates another example user interface for receiving a user query and for rendering query results, in accordance with an embodiment of the disclosure.

FIG. 8 is a functional block diagram of an example computer system upon which aspects of this disclosure may be implemented, in accordance with an embodiment of the disclosure.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high level, without detail, in order to avoid unnecessarily obscuring aspects of the present teachings.

To solve the aforementioned problems and certain other problems in the existing data extraction across various storage systems and databases within a cloud environment, the present disclosure provides a method and system that automatically generate a sequence of queries for a received single user query, where the generated sequence of queries, instead of the received user query, are used to search against the storage systems and databases. When generating the sequence of queries for data retrieval, the method and system disclosed herein first fetch metadata, sample data, or data source references (e.g., table names) from the attributed data source, and parse components included therein for analysis. The parsed data, along with the user-provided contextual query, are then provided to a text generation model for generating a sequence of queries. The text generation model, which could be a large language model (LLM) such as OpenAI's generative pre-trained transformer (GPT) or compatible models, produces a sequence of queries, which can be SQL queries, SQL-like queries, etc. The method and system disclosed herein then evaluate the sequence of SQL/SQL-like queries against the user's dataset and generate data analysis results based on the sequence of SQL/SQL-like queries. The results here may be a series of tables, aggregate numbers, or group-wise intelligent metrics, depending on the user's query and depending on the preference set by the user in advance. According to some embodiments, the method and system disclosed herein also package these results in a visualization-adjustable format for further rendering and data understanding.

The method and system disclosed herein show advantages when compared to other existing user query and data extraction applications. For example, by automatically generating multiple queries from a single user query, it may eliminate the requirement for a user to generate one query after another, which saves time and resources for handling user queries, for example, communication bandwidth between user devices and the server for handling user queries can be minimized. In addition, by generating multiple queries from a single user query and using the generated multiple queries to search against the storage systems and databases, it leads to more comprehensive search results when compared to using a single user query. Further, when generating multiple queries, these queries are generated based on the parsed data from the attributed data source, and thus the generated queries are more data source-focused, resulting in more targeted research results. Even more, when rendering the searched results for visualization, the disclosed method and system can perform certain data analysis such as data aggregation and summarization before presenting the retrieved raw data from the data source. The analyzed results can be automatically generated without additional actions from a user. In other words, a user does not need to actually touch or manipulate a dataset when the query results are generated and analyzed from the dataset. Under certain circumstances, the user even does not need to open the actual dataset. This becomes obviously an advantage when a user uses a device (e.g., a mobile phone or tablet) with limited functionalities and/or user interfaces for performing data analysis. Additional advantages of the disclosed method and system include a rendering of the search results and/or analyzed results in a visually appealing and understandable manner.

It is to be noted that the benefits and advantages described herein are not all-inclusive, and many additional features and advantages will be further described under the context of specific embodiments. In addition, some additional features and advantages will become apparent to one of ordinary skill in the art in view of the figures and the following descriptions.

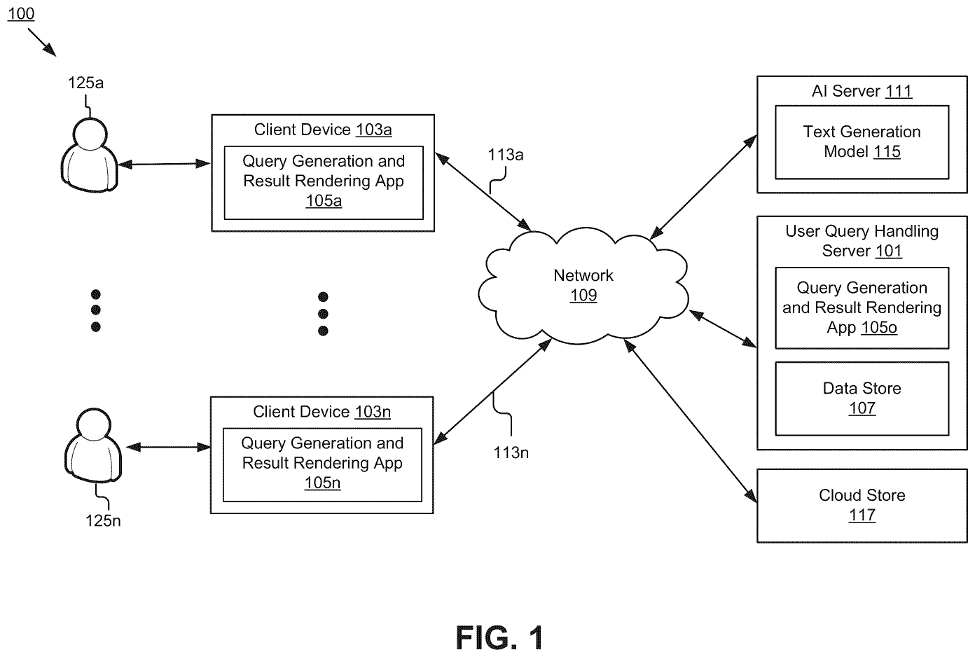

FIG. 1 is a block diagram of an example query generation and result rendering system 100. As illustrated, the system 100 includes one or more client devices 103a . . . 103n, where each client device includes a respective query generation and result rendering application 105a or 105n. Optionally, the query generation and result rendering system 100 may further include a user query handling server 101 communicatively coupled to the one or more client devices 103a . . . 103n via a network 109. A query generation and result rendering application 1050 may also be included in the user query handling server 101. In addition, to enable automatic query generation, the disclosed query generation and result rendering system 100 may further include an artificial intelligence (AI) server 111 that includes a text generation model 115 for generating a sequence of queries. It is to be noted that FIG. 1 is provided by way of example and the system 100 and/or further systems contemplated by the present disclosure may include additional and/or fewer components, may combine components and/or divide one or more of the components into additional components, etc. For example, the system 100 may include any number of user query handling servers 101, client devices 103a . . . 103n, or networks 109. For another example, the user query handling server 101 may include a text generation model 115, according to some embodiments.

The network 109 may be a conventional type, wired and/or wireless, and may have numerous different configurations, including a star configuration, token ring configuration, or other configurations. For instance, the network 109 may include one or more local area networks (LAN), wide area networks (WAN) (e.g., the Internet), public networks, private networks, virtual networks, mesh networks, peer-to-peer networks, and/or other interconnected data paths across which multiple devices may communicate. Network 109 may also be coupled to or include portions of a telecommunications network for sending data through a variety of different communication protocols. In some embodiments, network 109 includes Bluetooth® communication networks or a cellular communications network for sending and receiving data including via short messaging service (SMS), multimedia messaging service (MMS), hypertext transfer protocol (HTTP), direct data connection, wireless application protocol (WAP), email, etc.

The client devices 103a . . . 103n (or collectively client device 103) may include virtual or physical computer processors, memor(ies), communication interface(s)/device(s), etc., which, along with other components of the client device 103, are coupled to the network 109 via signal lines 113a . . . 113n for communication with other entities of the system 100. In some embodiments, the client device 103a . . . 103n, accessed by users 125a . . . 125n via input interfaces respectively, may send and receive data to and from other client devices(s) 103 and/or the user query handling server 101, and may further analyze and process the data. For example, the client devices 103a . . . 103n may communicate with the user query handling server 101 to transmit certain user inputs including certain user queries received through the user interfaces provided by the client device 103. The user query handling server 101 may analyze the user query, so as to generate a sequence of queries (e.g., by cooperation with the AI server 111) for data extraction from various storage systems and data sources. Non-limiting examples of client device 103 may include a laptop computer, a desktop computer, a tablet computer, a mobile telephone, a personal digital assistant (PDA), a mobile email device, or any other electronic device capable of implementing drawing or art software applications.

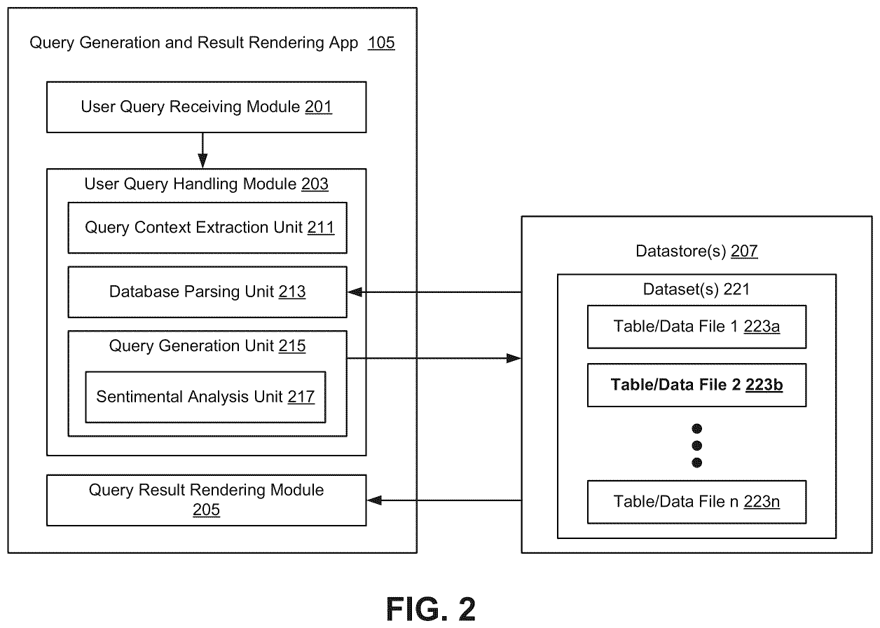

In some embodiments, the client devices 103a . . . 103n include instances of query generation and result rendering application 105a . . . 105n (or collectively query generation and result rendering application 105). The query generation and result rendering application 105 is representative of functionality relating to data extraction across various storage systems and data sources in a cloud environment, such as a cloud store 117. For example, the query generation and result rendering application 105 may include a set of modules configured to implement specific functions related to query generation and result rendering, as further described in detail in FIG. 2. In some embodiments, not all functions described in FIG. 2 are implemented by the client device 103.

The user query handling server 101 may be configured to implement partial or all functions related to the query generation and result rendering. For example, the user query handling server 101 may include an instance of query generation and result rendering application 105o (may also be referred to as query generation and result rendering application 105) for query generation and result rendering. In some embodiments, more complicated operations requiring a relatively large computation capacity (e.g., generating a sequence of queries and certain data analysis) may be implemented in the user query handling server 101, while some simpler operations (e.g., presenting results on a user interface) may be implemented on a client device 103.

Referring back to FIG. 1, in some embodiments, the disclosed system 100 may further include or may be coupled to, an AI server 111 configured to automatically generate a sequence of queries, for example, based on the contextual information extracted from the user query as well as the information parsed from the attributed database, as will be described in detail later. In some embodiments, the Al server 111 may include a text generation model 115 for generating the sequence of queries.

In some embodiments, the disclosed query generation and result rendering system 100 may further include a data store 107 configured to store data generated and/or required during the query generation and result rendering. The data store 107 may be included in the user query handling server 101 as illustrated in FIG. 1 or may be an independent data storage facility or a part of the cloud-based storage facility (e.g., cloud store 117), which is not limited in the disclosure.

Referring now to FIG. 2, specific functions of the query generation and result rendering application 105 are further described. As illustrated in the figure, an instance of query generation and result rendering application 105 may include a user query receiving module 201, a user query handling module 203, and a query result rendering module 205. In some embodiments, the query generation and result rendering application 105 may be coupled to various datastores 207 in a cloud environment, such as the data store 107 and the cloud store 117 shown in FIG. 1. In some embodiments, a datastore 207 may include one or more datasets 221, each of which may further include one or more tables or data files 223a to 223n.

The user query receiving module 201 may receive user queries through one or more user interfaces. For example, the disclosed query generation and result rendering application 105 may include a whiteboard for creating and visually displaying text and non-text objects in a drawing or art project. During the project, a user may input text through certain text tools included therein and/or draw a shape through certain drawing tools included therein. The user query receiving module 201 may receive these user inputs and take them as one or more user queries. In some embodiments, a user query may include merely text input. In some embodiments, a user query may further include certain commands in predefined formats, as described in the U.S. patent application Ser. No. 17/495,607, which is hereby incorporated by reference in its entirety. These predefined commands may indicate how the visual presentation of the search results should be rendered. For example, a user query may be: “Tell me the benefits about US patent system/stickynote.” In this example, “/stickynote” may be a predefined command, which indicates that the visual presentation of the search result is in the format of a sticky note. In addition, these predefined commands may also indicate whether data analysis should be performed for the data extracted based on the quer(ies). For example, a user query may be: Summary of Astronauts/dataanalysis.” In this example, “/dataanalysis” may be a predefined command, which indicates that data analysis should be performed for the data extracted based on the user query “Summary of Astronauts.”

In some embodiments, when receiving a user query, a target dataset related to the user query may be first identified. According to some embodiments, the dataset may be represented by an actual link or symbol displayed on a user interface, which may be the same user interface that also includes a user input window for inputting the user query. For example, the user may drag or upload a dataset from a cloud or local source through a user interface including a user query inputting window, thereafter the link or symbol for the dataset may be then displayed in the user interface. When a user query is received through the user query window (e.g., when the user types the query through the window), the query generation and result rendering application may automatically refer to the dataset link or symbol in the same user interface for data extraction. Optionally, in some embodiments, the link or symbol for the dataset may be pre-selected (e.g., through a click) before the user query is received and submitted to the system 100 through the user interface.

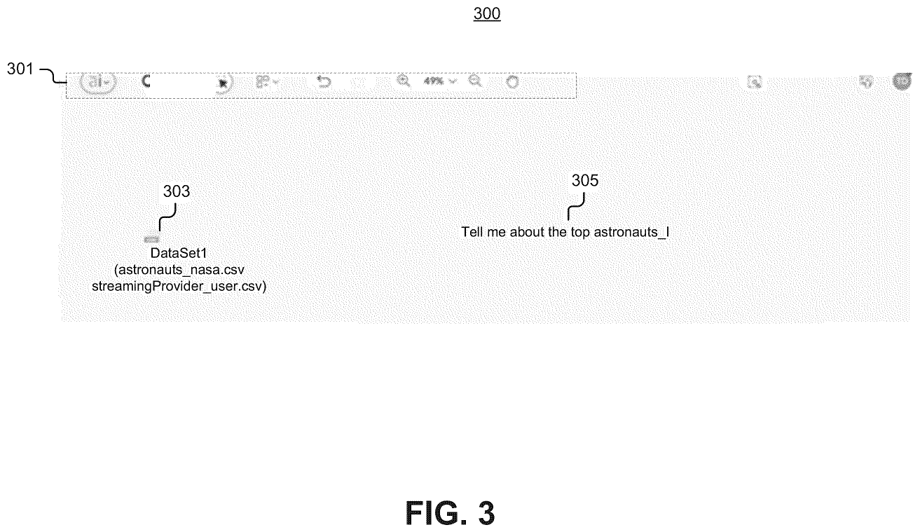

FIG. 3 illustrates an example user interface 300, in accordance with an embodiment of the disclosure. In the illustrated user interface 300, there are certain text or drawing tools 301. In addition, there is also a symbol 303 displayed on the user interface, which represents the target dataset from which a user query is intended to extract information. In some embodiments, a link is displayed instead, which can also be used to represent a target dataset. In either situation, the actual dataset (e.g., tables) is not displayed. The actual dataset may be located in the local or in a cloud environment but can be readily accessed when a user query is received.

In the illustrated user interface 300, there is also a user input window 305 for receiving user inputs. In one example, the user input may include a user query asking about the top astronauts included in the database 303. In some embodiments, there is no specifically configured window for user inputs. Instead, a user can initiate a user input in any place in the user interface. When the received user input includes a user query, the dataset 303 can be searched against based on the received user query. In one example, a sequence of queries can be automatically generated to search against the database 303.

In some embodiments, to determine whether a user input is a user query, a predefined action (e.g., double click and the like) or a predefined command (e.g., “/” and the like) may follow a user input to indicate that the user input is a user query. In some embodiments, no predefined action or command is needed. Instead, any user input received after a user referring to a dataset (e.g., right after a setup of data connection, through a clicking of an existing symbol or link, etc.) can be considered as a user query for the referred dataset.

Referring back to FIG. 2, the query generation and result rendering application 105 further includes a user query handling module 203 for generating a sequence of queries. For example, once the user query 305 is submitted through the user interface 300, the query generation and result rendering application 105 then automatically generates a sequence of queries based on the information included in the dataset 303 and the contextual information identified from the user query. For example, if the user query's subject matter is broad, the system conducts a deep analysis by generating between 10 and 20 SQL Select Queries, which facilitates providing sufficient but still relevant information related to the user query, so that the user does not need manually identify each parameter or subject before performing analysis one after another on the extracted information from the dataset.

Here the following is an example dataset:

<dataSet>
{
“dataLabel”: “StreamingProvider_user.csv”,
“tableName”: “o34e3.csv”,
“schemaWithSampleData”: “User ID Subscription Type Monthly Revenue Join
Date Last Payment Date Country Age Gender Device Plan Duration
1 Basic 10 15-01-22 10-06-23 United States 28 Male Smartphone 1 Month
2 Premium 15 05-09-21 22-06-23 Canada 35 Female Tablet 1 Month
3 Standard 12 28-02-23 27-06-23 United Kingdom 42 Male Smart TV 1 Month
4 Standard 12 10-07-22 26-06-23 Australia 51 Female Laptop 1 Month”
},
{
“dataLabel”: “astronaut_nasa.csv”,
“tableName”: “asw3a4.csv”,
“schemaWithSampleData”: “Name Year Group Status Birth Date Birth Place
Gender Alma Mater Undergraduate Major Graduate Major Military Rank
Military Branch Space Flights Space Flight (hr) Space Walks Space Walks
(hr) Missions Death Date Death Mission
Astronaut X 2004 19 Active 5/17/1967 Inglewood, CA Male University of
California-Santa Barbara; University of Arizona Geology Geology 2 3307
2 13 STS-119 (Discovery), ISS-31/32 (Soyuz)
Astronaut Y Retired 3/7/1936 Lewiston, MT Male Montana State
University; University of Colorado Engineering Physics Solar Physics 1
190 0 0 STS 51-F (Challenger)
Astronaut Z 1984 10 Retired 3/3/1946 Warsaw, NY Male US Military
Academy; Princeton University Engineering Aerospace Engineering Colonel
US Army (Retired) 2 334 0 0 STS-28 (Columbia), STS-43 (Atlantis) “
}
</dataSet>

As can be seen above, under certain circumstances, a dataset may include multiple data tables or data files (CSV), such as two tables or data files in the above example dataset. Each table or data file may contain data that is labeled for identification (e.g., ‘dataLabel’ such as “StreamingProvider_user.csv” and “astronaut_nasa.csv”) and organized under a specific pattern (‘tableName’) with a defined schema that outlines the data structure within the data file (‘schema WithSampleData’). In some embodiments, only one data table or data file is included in the dataset instead. In some embodiments, if there is more than one table or data file included in the dataset, the user query handling module 203 may first identify a specific table or data file included in the dataset. In other words, the user query is placed in the context of the dataset when generating the sequence of queries, so that only relevant table or data file is used for data extraction when generating the sequence of queries.

Referring back to FIG. 2, the user query handling module 203 may include a query context extraction unit 211, which is configured to extract the context information (e.g., keywords included in the user query) for identifying the specific table or data file included in the dataset. For example, as shown in FIG. 2, there may be a series of tables or data files 223a to 223n in a dataset 221. When generating the sequence of queries, the relevant table or data file (e.g., table/data file 2 223b) is first identified based on the user query, e.g., based on contextual information such as keywords included in the user query. For example, in the aforementioned tables in the dataset 303 in FIG. 3, if the user query is asking about the top astronauts, then only data in the table “astronaut_nasa.csv” includes information related to astronauts and thus only that table will be used to generate the sequence of queries, and will be further used to generate query results for these queries. The other table “StreamingProvider_user.csv” does not contain information about astronauts and thus will not be used to generate the sequence of queries, not even to mention the query results for these queries.

In some embodiments, the user query handling module 203 may additionally include a database paring unit 213 for parsing the information included in the dataset (more specifically, the relevant table or data file) when generating the sequence of queries. For example, for the table “astronaut_nasa.csv”, when the user query is asking about the top astronauts, the sequence of queries may be generated by looking at the characters in each column. For example, the sequence of queries may be generated by ranking the astronauts according to the feature in each column. Accordingly, the generated sequence of queries may include one query for “top astronauts based on their nationality,” one query for “top astronauts based on their mission count,” one query for “top astronauts based on their EVA (extra-vehicle activity) hours,” among other possible queries generated based on the content (e.g., column features) in the table.

Here the following is an example user query passed onto the query generation and result rendering application 105 disclosed herein:

<userQuery>
{
“content”: “Top Astronauts”
}
</userQuery>

From the above user query, it can be seen that the user is interested in finding the top astronauts from the dataset that may include data related to astronauts. The user does not provide further details in the user query. However, when the query generation and result rendering application 105 receives the user query, a sequence of queries may be automatically generated and applied to the dataset. The sequence of queries may be generated based on the user query as well as the context included in the dataset (e.g., column features) so that the results can be obtained for the generated sequence of queries.

Referring back to FIG. 2, the user query handling module 203 may additionally include a query generation unit 215 that is configured to generate a sequence of queries based on the user query and the content included in the target table or data file included in the dataset. In some embodiments, the query generation unit 215 may include or may be coupled to a text generation model, which can be an LLM for automatically generating the sequence of queries. Here the following is an example pseudocode for generating the sequence of queries:

// LLM is instructed to learn the context of the dataset from the
prompt
// LLM takes the user input in natural language as parameter of the
prompt
// prompt askes the LLM to decided which table, column and sequence of
queries to construct
// generate queries using LLM
const generatedQueries = LLMTextGeneration(parsedData, userQuery);

From the above, it can be seen that LLM is instructed to decide which table is used to generate the sequence of queries, for example, based on the information learned from the user query by taking the user query in natural language as a parameter of the prompt. In addition, the LLM is instructed to learn the context of the relevant table or data file, so as to determine which columns are used to generate the corresponding queries. For example, for the aforementioned table “astronaut_nasa.csv”, the generated sequence of queries may include a sequence of queries for identifying top astronauts according to nationality, mission count, gender, etc., all of which can be related to a feature associated with a column in the table or data file.

In some embodiments, when generating the sequence of queries, sentiment analysis may also be performed to facilitate the process of generating the queries. Here the following is an example pseudocode for such purposes:

///// Ask LLM if any of user input and any columns looks like Sentiment
analysis
///// If its Sentiment Analysis then it would check if it has a
classification column that can be associated with user input if not
then create a list of classifications and use a text classifier model
to create a new temporary column for the associated table or virtual
table and insert the type of classifications keywords in that column
from user input, it would also ask LLM to create a list of keywords for
classification type (e.g. Mad, Sad, Glad)... if preexisting
classification column or newly created classification column, it would
create SQL Statement with those keywords

From the above pseudocode, it can be seen that, in some embodiments, the query generation and result rendering application 105 may further perform a sentimental analysis on the user query and/or relevant table or data file. For example, the sentimental analysis unit 217 may be included in the user query handling module 203 and is configured to check whether there is a classification column for sentiment in the table or data file, and may generate a temporary column for sentiment classification if there is no such a column. Certain classification keywords (such as mad, sad, and glad) may be also created and used to classify the sentiment for the content in the relevant table or data file. In some embodiments, the sentiment classification may be used to generate user queries. For example, if a user query asks about the customer experience at a coffee shop, three user queries may be generated to ask what makes customers mad, sad, or glad about the coffee shop. These three queries may be used as a sequence of queries to search against a table or data file to identify relevant information related to the queries. In some embodiments, since the table or data file includes a column for sentiment classification, the related information can be easily identified from the relevant table or data file.

In some embodiments, the sequence of queries generated by the text generation model such as LLM may be SQL queries (e.g., SQL statements). Accordingly, in preparing answers to the generated sequence of queries, the query generation and result rendering application 105 may leverage a SQL-compatible database service provider, such as PostgresSQL, MySQL, and AlaSQL (in this sample values in the prompt), which enables computational processes to be performed using SQL logic on the relevant table or data file included in the dataset.

In some embodiments, the method and system disclosed herein may also include certain rules specifying SQL query instructions or statements, generated by the text generation model 115, for SQL-compatible database service providers. For example, for the provider AlaSQL, the rule(s) may specify: the ‘tableName’ keyword should be replaced with a ‘?’ symbol. Also, certain keywords and patterns specific to the database service, such as not using ‘Group’ and ‘Count’ as an Alias and using ‘TOP’ or ‘LIMIT’ to manage the returned dataset's size should be followed. In some embodiments, based on the specified rules, the SQL data service provider may return certain query results in response to the generated sequence of queries.

Referring back to FIG. 2, in some embodiments, the query generation and result rendering application 105 may further include a query result rendering module 205 for providing a visual presentation of the query results in a visually appealing and understandable manner.

In some embodiments, the query results are organized as a JSON file that may include query title (‘t’), descriptive details (‘n’), and specific sections (‘ts’) that contain the context (‘tq’), name (‘tp’), and details of each query included in the sequence of queries. This includes the ‘dataLabel’ (‘dl’), ‘tableName’ (‘s’), chart title (‘l’), chart type (‘c’), SQL query (‘x’), and how the return data would help determine the subject matter of the ‘UserQuery’ (‘y’) (i.e., the query input by the user). In some embodiments, the query results may be organized in other different formats, which is not limited in the present disclosure.

Here the following is an example pseudocode for generating a visual representation of the query results:

// Execute generated queries and get result
const result = queryExecution(generatedQueries);
// Process results for visualization
const visualizationReady = postProcessQueryResults(result);
// return visualization-ready data
return visualizationReady;

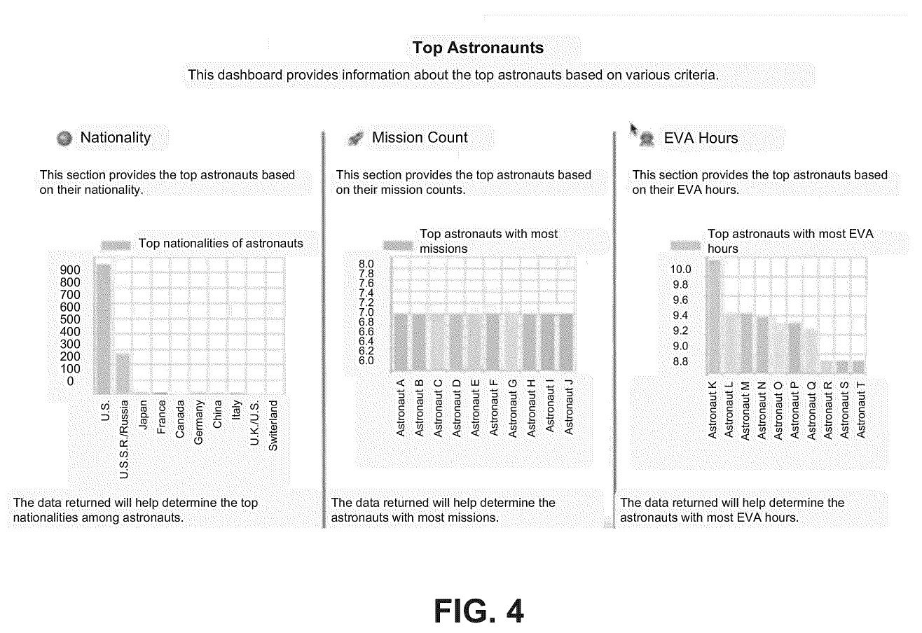

FIG. 4 illustrates an example visual representation of query results, in accordance with an embodiment of the disclosure. As illustrated, the query results may be generated based on the generated queries related to three columns, such as columns related to nationality, mission count, and extra-vehicle activity (EVA) for the astronauts included in the table or data file. For example, the left plot provides information indicating that the U.S. has the most top astronauts, the middle plot provides top astronauts that have the most mission count, while the right plot provides top astronauts that have the most EVA hours. In some embodiments, if there are additional columns, there may be additional queries generated for the additional columns, and thus the query results may include additional plots corresponding to these columns.

Under certain circumstances, the user query may not match the context included in a dataset included in the same user interface. In one example, a user query asks about astronauts, but the target dataset does not include information about astronauts (e.g., if the DataSet1 in FIG. 3 does not include the “astronaut_nasa.csv” data file). Under such a circumstance, an error may be returned instead without providing query results as expected. In some embodiments, insightful information (‘e’) may accompany the error, explaining why the process couldn't be executed.

It should be noted that, in the method and system disclosed herein, the implementation of a specific user query is focused on the accuracy and analytical processing in answering the user query by directing to the right portion(s) and schema of the table(s) or data file(s), ensuring the reliability of returned results. Under certain circumstances, if the application cannot generate a satisfactory answer, the application may honestly communicate its inability to do so without concocting incorrect responses.

Here the following is an example pseudocode for implementing the above-described various processes:

```
  // Define procedure generateQueriesByUserPrompt
  defineProcedure generateQueriesByUserPrompt:
  input: userQuery (string), dataSet (JSON object)
  output: outputData (JSON object)
  // Start the process
  start:
  // Parse the supplied dataSet which includes ‘dataLabel’, ‘tableName’,
  and ‘schemaWithSampleData’ from each provided structured table
  parsedDataSet = parseDataSet(dataSet)
  // Specify the data service provider, it can be any provider like
  MySQL, PostgresSQL, Microsoft SQL Server, etc.
  Provider = getDatabaseProvider( )
  // Define some rules and instructions for generating queries specific
  data service provider
  queryInstructions = generateQueryInstructionsWithProvider(Provider)
  // Define supported chart types for data visualizations
  chartTypes = list(‘pie’, ‘bar’, ‘doughnut’, ‘line’, ‘table’,
  ‘singleNumber’, ‘none’)
  // Now, create queries based on the user query in the context of the
  dataset
  for each data in parsedDataSet:
    // Check if data matches with userQuery
    if data matches with userQuery:
    providerQueries = createProviderQueries (userQuery, data, Provider,
  queryInstructions)
  // Execute each SQL/Provider query and format the result in a JSON
  format including ‘Title’, ‘About’, ‘Section purpose’, ‘Emoji icon’,
  ‘Section name’ and other details
    for each query in providerQueries:
    queryResult = executeProviderQuery(query, Provider)
    formattedResult = formatQueryResult(queryResult, chartTypes)
    outputData.append(formattedResult)
  // If the user query doesn't match any data in the dataset, return an
  error in JSON format with meaningful error details
  if not outputData:
    outputData = generateErrorMessage(userQuery)
  // If the scope of the user query is broad, generate and execute
  additional queries (from 10 to 20)
  if isUserQueryBroad(userQuery):
    moreProviderQueries = generateMoreQueries(userQuery, parsedData,
  Provider, queryInstructions)
    for each query in moreProviderQueries:
    queryResult = executeProviderQuery(query, Provider)
    formattedResult = formatQueryResult(queryResult, chartTypes)
    outputData.append(formattedResult)
  // The system should be very analytical and must ensure returning
  results from the right column name and schema
  outputData = checkAnalyticalAccuracy(outputData)
  // If the system can't generate a satisfactory answer, it should
  communicate its inability without generating incorrect responses
  if not outputData:
    outputData = generateUnableMessage(userQuery)
  // At this point, the process will output the formatted JSON data for
  visualization or any further processes
return outputData
```

According to the above pseudocode, the process for generating the sequence of queries and presenting query results for a received user query may start by parsing a supplied dataset, which includes ‘dataLabel’, ‘tableName’, and ‘schemaWithSampleData’ from each provided structured table. A data service provider is then specified for data extraction from the dataset, where the data service provider can be any provider, like MySQL, PostgresSQL, Microsoft SQL Server, etc. Some rules and instructions for generating queries specific to the data service provider are further defined or identified. In some embodiments, supported chart types for data visualizations are also defined, which may include but are not limited to a pie, a bar, a doughnut, a line, a table, a single number, etc. In the next, the sequence of queries are generated based on the user query in the context of the dataset. For example, it is first checked whether a relevant table or data file matches the user query. If the relevant table or data file matches the user query, a sequence of provider queries (e.g., queries compatible with the service provider) are then created. After the query generation, each provider query (e.g., SQL statement) is executed by the corresponding service provider, to obtain the corresponding query result. In some embodiments, the query results are formatted in a JSON form, including ‘Title’, ‘About’, ‘Section purpose’, ‘Emoji icon’, ‘Section name’ and other details for the obtained query results. If the user query doesn't match any data in the dataset, an error is returned in JSON format with meaningful error detail explain why no query result is obtained. In some embodiments, if the received user query is broad, additional queries may be further generated, e.g., additional 10 queries may be further generated, so as to extract additional information, to make sure sufficient but still relevant information is provided in response to the user query.

In some embodiments, the method and system disclosed herein are very analytical and must ensure returning results from the right column name and schema for each data in the parsed dataset. If the system can't generate a satisfactory answer, the system may communicate its inability without generating incorrect responses. In some embodiments, once the proper query results are obtained, the query results are formatted in a JSON format or other proper formats for visualization or any further processes (e.g., additional data analysis).

In some embodiments, additional (e.g., second round of) query results may be also generated based on additional questions or search parameters (e.g., second user query) provided by the user beyond the first user query received through the query input window. That is, there may be two user queries and two rounds of data rendering processes. Different from the first user query, the second user query may be more related to the information provided in the query results out of the first user query. Using the table “astronaut_nasa.csv” and the first query asking for “top astronauts” as an example, after the query results and multiple charts for top astronauts are rendered for presentation to the user, the user may input another query asking for strength, weakness, opportunity, and threat (SWOT) analysis for astronauts. This second user query may be still forwarded to the query generation and result rendering application 105, which may generate query results based on the information (e.g., query results) obtained from the first user query. During the process, a second sequence of queries may be generated from the second query, which are different type of queries from the first sequence of queries.

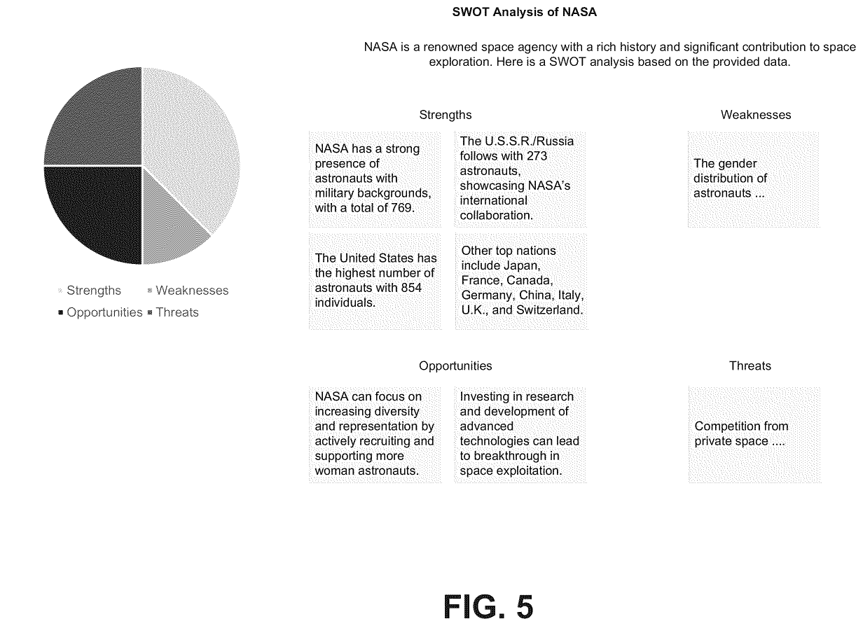

FIG. 5 illustrates an example SWOT analysis from a second user query, in accordance with an embodiment of the disclosure. The second user query may be generated based on the first user query, for example, based on the relevant table or data file identified from the first user query, or based on the information obtained from the first user query. In another example, if the first user query provides the information for astronauts according to nationality, the user may ask a second query to inquire how many astronauts in the U.S.S.R./Russia are from the U.S.S.R. and how many astronauts are from Russia.

### Overall Implementation

Here the following is an example pseudocode for implementing an overall query generation and result rendering process, in accordance with an embodiment of the disclosure:

// User connects with database or uploads data files (csv, excel, json)
on canvas
// User asks a query in natural language
// Fetch limited dataSet to the source to understand table name,
columns and data patterns
const contents = fetchContentFromDataSource(boardId);
// Construct the Data Analysis prompt with <dataSet> and <userQuery>
return JSON instruction/data
// Parse the fetched data and prepare the input to be provided to the
LLM
const parsedData = parseFetchedData(contents);
// Generate queries using LLM
const generatedQueries = LLMTextGeneration(parsedData, userQuery);
// Execute generated queries and get result
const result = queryExecution(generatedQueries);
// Process Query results for Data visualization
const visualizationReady = postProcessQueryResults(result);
// Return Query visualization-ready data
return visualizationReady;
// Render Query visualization-ready data on Canvas
renderDataOnCanvas(visualizationReady);
// Process Query results for LLM Analysis
const analysisData = analyzeQueryResults(result);
// Return Analysis in visualization-ready data
const visualizationReadyAnalysis =
prepareDataForVisualization(analysisData);
// Render Analysis on Canvas
renderAnalysisOnCanvas(visualizationReadyAnalysis);

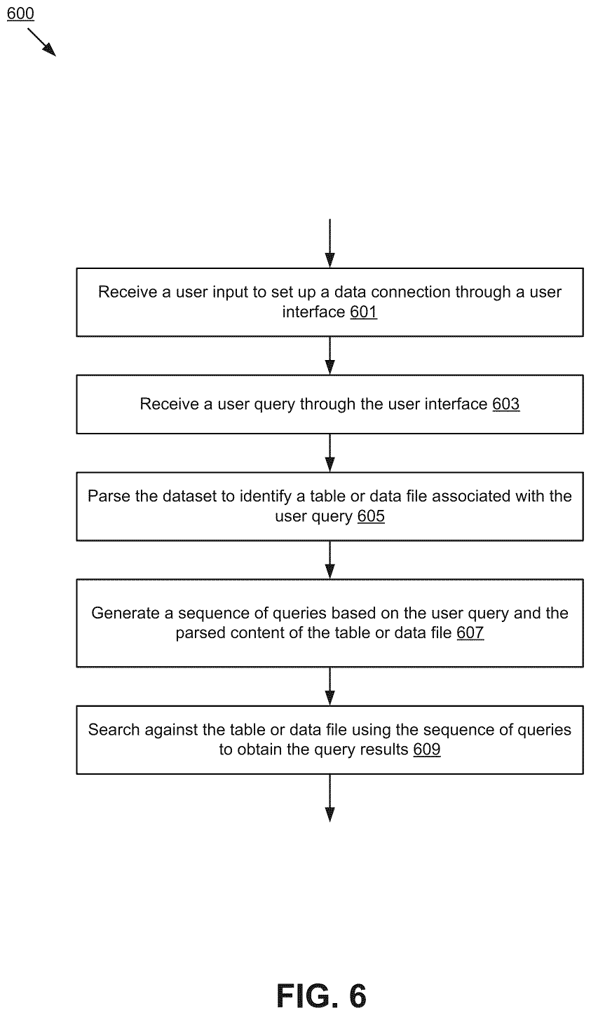

FIG. 6 illustrates a flow chart of an example method 600 for handling a user query, in accordance with an embodiment of the disclosure. The method 600 may be implemented following the above pseudocode. Briefly, method 600 includes step 601 for receiving a user input through a user interface, the user input is to set up a connection with a dataset (e.g., a dataset in the cloud) or upload a data file. At step 603, method 600 includes receiving a user query, in the natural language, through the user interface, where the user query is intended to extract information from the dataset. At step 605, method 600 includes parsing the dataset to identify a table or data file associated with the user query. For example, method 600 includes fetching or parsing the dataset to understand the file name, columns, and data patterns, and performing data analysis on the dataset and the user query, which may include identifying, from the dataset, the table or data file associated with the user query. At step 607, method 600 includes generating a sequence of queries based on the user query and the parsed content of the table or data file, as described elsewhere herein. At step 609, method 600 includes searching against the table or data file using the sequence of queries to obtain the query results. In some embodiments, the query results are processed to allow the search results to be rendered in a predefined format of data visualization. In some embodiments, the query results may be further processed for data analysis, such as data aggregation. Accordingly, in some embodiments, the analyzed data is rendered in a predefined format for data visualization. In some embodiments, if the user query is broad, additional user queries may be further generated, which can be used to search against the table or data file to obtain additional query results in response to the broad user query.

### Specific Implementation

Hereinafter is an example of a specific implementation of the disclosed query generation and result rendering, in accordance with an embodiment of the disclosure. The implementation may be executed in a drawing or art design application environment. In other words, the disclosed query generation and result rendering application may be a part of the drawing or art design application that includes a set of text tools and drawing tools for generating certain text and non-text objects in a user interface(s).

### Part 1: Initiate From a Canvas Application

According to the method and system disclosed herein, the specific implementation may start with a user query-handling code in the application. According to one example, the code may be ‘AiQueryCommand’ class used in the context of a drawing or art design application, such as a drawing board or online canvas application. ‘AiQueryCommand’ is a type of ‘SlashCommand’ that responds specifically to queries prompted by users. For example, when a user types in a command ending with ‘/aq’ or ‘/dataanalysis’, this ‘AiQueryCommand’ code may parse the command and send the accompanying user query to an AI service. In some embodiments, the ‘AiQueryCommand’ code may actually be part of a larger application that is used to generate and draw charts or diagrams based on textual inputs or commands using training with prompts for LLM-based text generation AI service.

Here is an example pseudocode of the key components included in the code for handling the user query:

```
plaintext
Class AiQueryCommand extends SlashCommand
  Properties:
  command // String that represents the slash command.
  activeObject // Currently selected object in the Canvas.
  aiService // Instance of the AI Service.
```

### Part 2: Configuring Cloud Storage or Database

As described earlier, the dataset for user query is based on a cloud-stored dataset (the local storage is possible, but its implementation is not specially described here). Accordingly, the configuration of the system 100 disclosed herein may include a connection of the system with a cloud storage, such as Amazon S3, Google Cloud, Microsoft Azure, or any other cloud database and filesystem. The specific configuration may include setting up the necessary environment variables, initializing the clients, and ensuring secure and appropriate access privileges.

Here the following is an example pseudocode for configuring cloud storage:

```
// Use Dependency injection with ‘tsyringe’ library to maintain single
instance of services
const providerDB = container.resolve(‘DynamoDB’);
const providerStorage = container.resolve(‘S3’);
// Configure the clients with the necessary environment variables
const config = new Config({
  providerDB: {
    . . . // necessary configurations
  },
  providerStorage: {
    . . . // necessary configurations
  }
});
// Initialize the clients
providerDB.init(config.dynamoDB);
providerStorage.init(config.s3);
```

### Part 3: Contextual Data Extraction and Query Generation

### Step 1: Contextual Data Extraction

According to some embodiments, once the connection between the system disclosed herein and the dataset in the cloud is established, the cloud storage may be accessed. The system may then fetch the metadata, schema, and sample data from every table included in the dataset. This initial dataset may be further passed on to a machine learning model in a structured format, like a JSON file including the data label (original filename), table name (filename), and a sample data (schema with sample data). In some embodiments, the aforementioned LLM may be a part of the machine learning model disclosed herein, or the LLM model itself is the machine learning model disclosed herein.

Here the following is an example pseudocode for contextual data extraction

// Instantiate the query object with dependencies
const queryObject = new Query(config, ExceptionReporter, providerDB,
providerStorage);
// Get metadata for each cloud storage provider dataset
let headerData = await queryObject.getHeaderData(boardId);
headerData = headerData.split(‘, \n’).map(JSON.parse);
// Pass headerData to Machine Learning Model to generate query sequence
const querySequence = await LLM.generate(headerData, userQuery);
‘‘‘
//Sample Data and Schema along with table name or file name
‘‘‘
{
″metadata″: {
″dataLabel″: ″OriginalFilename″,
″tableName″: ″Filename″,
″schemaWithSampleData″: ″SchemaWithSampleData″
}
...
}

Step 2: Query Generation with a Machine Learning Model

A machine learning model (such as GPT-3 or any other compatible text generation model) may be utilized to generate the query instructions (i.e., the aforementioned sequence of queries) based on the structured dataset using a predefined set of rules. The machine learning model generates a series of SQL queries for diverse data points bound by the dataset constraints.

Here the following is an example pseudocode for generating the sequence of queries:

```
// User Query is passed to the model along with the headerData
const userQueryResponses = LLM.executeQuery(headerData, userQuery);
// Returns a sequence of queries in the given format
return userQueryResponses
  .map(
  (res) => ‘{″t″: ″${res.title}″, ″n″: ″${res.note}″, ″ts″:
${JSON.stringify(res.items)}}‘
  )
  .join(‘,\n’);
```

### Part 4: Data for Visualization

According to some embodiments of the disclosure, generated queries may be further passed on to the data extraction and query generation unit, which may be the same data extraction and query generation unit used for processing the user query. Different from the earlier process for generating the sequence of queries described earlier, the data extraction and query generation unit may instead generate the output for the sequence of queries based on the actual content of the dataset (that is, instead of the column characters, the actual data value or data content in the cells of the table). The data for the visualization unit may then fetch the output of these SQL queries from the connected dataset, and then generate a visual presentation on a canvas. The visualization type may include but is not limited to pie, bar, doughnut, line, table, single number, etc. The exact visualization type may be selected based on the data type and distribution or may be selected by the machine learning model based on the insights identified from the data process. In some embodiments, when generating the visual presentation of the query results, certain data analysis may be also performed, e.g., such as ratio, percentage, cumulative, etc., which may be calculated for the query results.

Here the following is an example data object generated based on the query result of one of the sequence of queries. The example data object ‘IDrawingObject’ may include the following information:

- id: to uniquely identify the data object
- timestamp: the timestamp of the object's creation
- objects: an optional array to store related IDrawingObject instances
- data: the actual data in key-value pairs

According to some embodiments of the disclosure, an ‘IQuery’ interface may be further employed to structure the queries to maintain uniformity across all SQL queries including the results of the queries, as shown in the following:

- s: source/table name
- l: name of dataset
- c: chart type for visualization
- x: the SQL query itself
- y: the meaning or purpose of query
- r: the results of the query

According to some embodiments of the disclosure, the final result of the model's text generation would be in the form ‘IResult’, which may include:

```
- tq: Query Title
- tp: Description or purpose of data extraction
- q: Array of IQuery items.
‘‘‘
interface IQuery {
  s: string;
  l: string;
  c: string;
  x: string;
  y: string;
  r?: string;
}
interface IResult {
  tq: string;
  tp: string;
  q: IQuery[ ];
}
```

Here the following is an example pseudocode for generating the query results for visual presentation:

```
// Pass the querySequence to the query object to generate the data for
the visualization
let queryOutput = await queryObject.getQueryOutput(boardId,
JSON.parse(querySequence));
queryOutput = queryOutput.map(JSON.stringify).join(‘,\n’);
‘‘‘
The JSON structure from Part 3 above:
‘‘‘
{
  ″dataLabel″: ″FileName″,
  ″tableName″: ″FilenameUsedInDB″,
  ″schemaWithSampleData″:
  ″ExampleDataWithColumnNamesDisplayedAsCSV″,
  ...,
}
New JSON structure in this step:
  ″tq″: ″QuerySectionTitle″,
  ″tp″: ″PurposeOfTheQuery″,
  ″q″: [
  {
  ″s″: ″TableName″,
  ″l″: ″EmojiSymbol + QueryTitle″,
  ″c″: ″ChartType″,
  ″x″: ″SQLQuery″,
  ″r″: ″‘ResultFromSQLQuery’″,
  ″y″: ″ExplanationOfDataOutput″
  },
  ...
  ]
}
```

In the above pseudocode, ‘dataLabel’ refers to the label or name of the data file. It could be any file that is included in the dataset. ‘tableName’ refers to the name assigned to this particular table or data file or views when it is stored or used in the database. ‘schema WithSampleData’ signifies the data schema, which shows a sample or example of the data structure found within the file. The schema typically outlines column names and their corresponding data in a database table or CSV format.

Following on with the structure, an array begins featuring SQL queries related information. ‘tq’ refers to the title of the query section. It is the section in which the following queries are categorized under or belong to. ‘tp’ is for defining the purpose or aim of the query. It explains why the query is being executed.

Inside this array, each object is a detailed representation of the SQL query and its details. Specifically, ‘s’ is the ‘tableName’, which refers to the specific table that is targeted by the SQL query in context. ‘l’ represents a combined output of ‘EmojiSymbol+QueryTitle’. It can be used to give users a quick, graphical understanding of the query. ‘c’ refers to ‘chartType’, describing what type of chart will be used to visualize the query's results. ‘x’ stands for the executed ‘SQLQuery’, which has been used on the dataset. ‘r’ is the key that returns the ‘ResultFromSQLQuery’, which is the outcome of executing the SQL query. ‘y’ is an ‘ExplanationOfDataOutput’, a way to provide the context or further description about the query's result. This helps users understand the meaning or implications of the result.

### Part 5: Render Dashboard (Query Results)

According to some embodiments, the system disclosed herein may employ a system for transforming query results into a formatted dataset for visual display. For example, the employed system may automatically organize the display of certain text or non-text objects, which may be also referred to as a visual information design system (VIDS), according to some embodiments. The automatically generated visual layout of the text or non-text objects can be in many different formats, such as templates, diagrams, flow charts, wireframes, and the like. To achieve the aforementioned functions, according to one embodiment, the VIDS system may be configured to create a structured dataset (into JSON) for the specific visual layout for the visual representation of the data. For example, the VIDS system may combine various elements to transform the query results into a specific JSON object, depending on the desired visual output. In some embodiments, specific programs or modules are configured to transform the query results into a formatted dataset that can be used to generate various types of dynamic designs (also referred to as dynamic design systems (DDS)) for rendering visual information, such as text (DXDS), templates (DTDS), diagrams (DDDS), wireframes (DWDS) and so on. These programs or modules, once configured, allow to dynamically generate data representations (e.g., visual layouts) that are both meaningful and intellectually engaging. The specific detail may refer to the U.S. patent application Ser. No. 17/495,607, which is hereby incorporated by reference in its entirety.

### Part 6: Process Dashboard Data (from Part 5) to LLM for Analysis and Render the Analysis on Canvas

Briefly, from Part 4, it takes the ‘l’: ‘QueryTitle’, ‘r’: ‘ExplanationOfDataOutput’ along with user's original query in <userQuery>and then sends it to ‘AiTemplateCommand’, as described in Part 5. In this way, the analyzed data may be rendered for presentation.

In the following, certain key points of the above implementations are further emphasized or repeated.

The method and system disclosed herein take an instance of ‘AiService’, which is used to interact with the AI server, as an argument in the constructor.

The ‘execute’ method takes the query from the user and sends it to the AI service. It also stores relevant task information in the ‘aiTaskInfoMap’ dictionary for future reference.

The ‘randomColor’ method is used to generate a random color in hexadecimal format. This could be used when drawing charts or visualizations.

The ‘draw’ method attempts to draw the results of the AI query on the drawing board. It retrieves query results from the AI service and creates visualizations such as charts or graphs using these results.

Error handling is also implemented. If any exceptions are thrown during the execution of the ‘draw’ method, ‘ExceptionReporter.report( )’ is called to log the error.

In summary, the ‘AiQueryCommand’ class forms a crucial component of the application's AI functionality. With this feature, the system can automate the process of creating complex charts and diagrams by simply querying an AI service.

Here, the class ‘AiQueryCommand’ may be a part of a larger application that is used to generate and draw charts or diagrams based on textual inputs or commands, using an external AI service.

Although not illustrated, in some embodiments, detailed error handling and logging are in place, to account for any potential issues during the execution of AI tasks and visualization drawings, as described above.

Here the following is an example pseudocode of the key components:

```
Class AiQueryCommand extends SlashCommand
  Properties:
  command // String that represents the slash command.
  activeObject // Currently selected object in the Canvas.
  logger // Instance of a logger service.
  aiService // Instance of the AI Service.
  Constructor (canvas, userInputText, board, aiService):
  Set local class properties.
  Method randomColor( ):
  Generate and return a random color in hexadecimal string format.
  Method getChartKey(results):
  Extract and return the chart keys from result data.
  Method getAllKeys(results):
  Extract and return all keys present in the results.
  Method execute( ):
  Parse and extract the user query from command input.
  If an textbox object is currently active in Canvas, update its
  content
with user query.
  Pass the user query to the AI Service and save the returned
  task in
aiTaskInfoMap.
  Method draw(data):
  Instantiate a new AiGeneratedTemplate.
  Parse and extract necessary data for visualization from the result
returned by the AI service.
  Create the necessary visualizations and add them to the Canvas
  using
the AiGeneratedTemplate (inherited from Dynamic Template
Design System
- DTDS).
  Handle and report any exceptions that occur during the process.
```

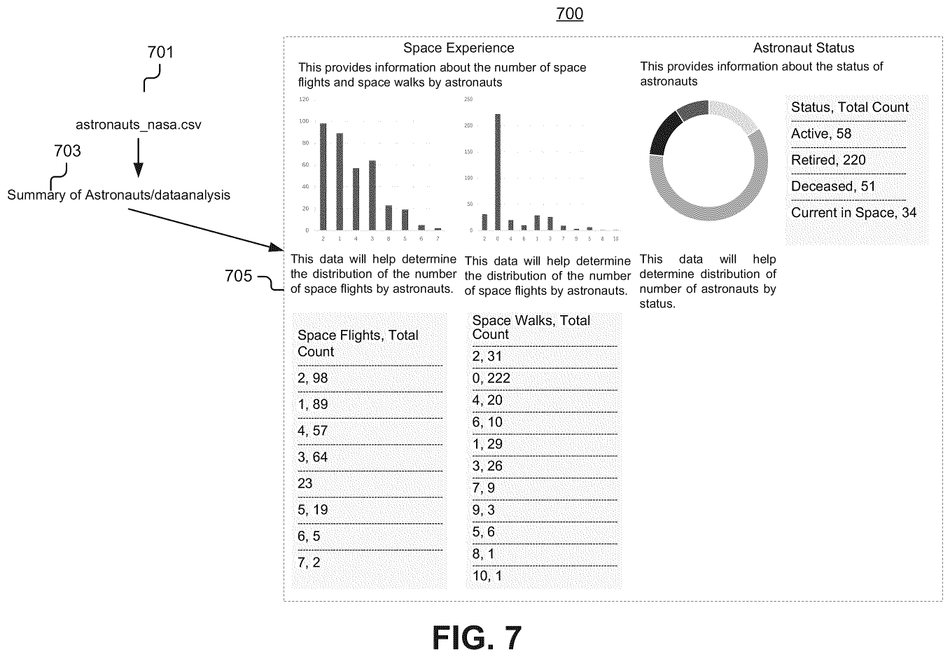

FIG. 7 includes an example user interface for handling a user query, in accordance with an embodiment of the disclosure. In the illustrated user interface 700, a symbol or link 701 connected with a dataset may be set up by a user through the user interface. In the next, a user input 703 including a user query is received through the same user interface. The user query asks for a summary for the astronauts included in the dataset set up in the same user interface (e.g., through the symbol or link 701 for connection with the actual dataset in the cloud environment). As can be also seen from the user input 703, a predefined command “/dataanalysis” follows the actual user query “summary of astronauts.” This means a further data analysis will be performed on the extracted data by the associated AI service or other data analysis applications included in or coupled to the query generation and result rendering application 105. In response to the user query, query results 705 are analyzed and presented to the user in predefined data visualization formats, for example, including one or more outcomes of data analysis. From FIG. 7, it can be seen that the query results may be rendered in different formats. While not shown, these different query results may be generated based on a sequence of queries, which is generated based on the user query and parsed content from the dataset as described elsewhere herein.

By the means of the above-described method(s), it is possible to efficiently tap into distributed data sources, generate useful and intuitive queries, analyze the data, and visualize it in a user-friendly format. This can serve as a powerful tool for businesses and organizations to employ their data in a more effective and insight-driven manner.

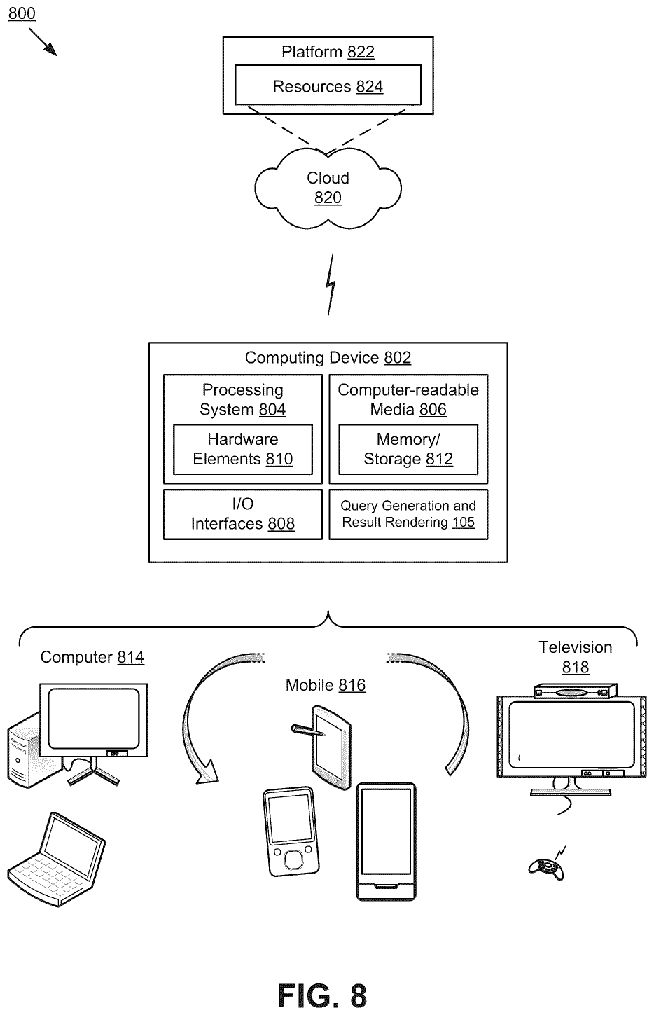

FIG. 8 illustrates an example system 800 that, generally, includes an example computing device 802 that is representative of one or more computing systems and/or devices that may implement the various techniques described herein (e.g., for transforming AI response into a formatted dataset for visual display). The computing device 802 may be, for example, a server (e.g., a user query handling server 101) of a service provider, a device associated with a client (e.g., a client device 103), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, from one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of the functionality to perform one or more operations using hardware. Accordingly, the processing system 804 is illustrated as including hardware element 810 that may be configured as processors, functional blocks, and so forth. This may include implementation in hardware as an application-specific integrated circuit (ASIC) or other logic devices formed using one or more semiconductors. The hardware elements 810 are not limited by the materials from which they are formed, or the processing mechanisms employed therein. For example, processors may be comprised of semiconductor(s) and/or transistors, e.g., electronic integrated circuits (ICs). In such a context, processor-executable instructions may be electronically executable instructions.

The computer-readable storage media 806 is illustrated as including memory/storage 812. The memory/storage 812 represents memory/storage capacity associated with one or more computer-readable media. The memory/storage component 812 may include volatile media (such as random-access memory (RAM)) and/or nonvolatile media (such as read-only memory (ROM), Flash memory, optical disks, magnetic disks, and so forth). The memory/storage component 812 may include fixed media (e.g., RAM, ROM, a fixed hard drive, and so on) as well as removable media, e.g., Flash memory, a removable hard drive, an optical disc, and so forth. The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movements as gestures that do not involve touch), and so forth. Examples of output devices include a display device (e.g., a monitor or projector), speakers, a printer, a network card, a tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal-bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage devices, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer-readable instructions, data structures, program modules, or other data in a modulated data signal, such as carrier waves, data signals, or other transport mechanisms. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 810 and computer-readable media 806 are representative of modules, programmable device logic and/or fixed device logic implemented in a hardware form that may be employed in one or more implementations to implement at least some aspects of the techniques described herein, such as to perform one or more instructions. Hardware may include components of an integrated circuit or on-chip system, an ASIC, a field-programmable gate array (FPGA), a complex programmable logic device (CPLD), and other implementations in silicon or other hardware. In this context, hardware may operate as a processing device that performs program tasks defined by instructions and/or logic embodied by the hardware as well as hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through the use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

As further illustrated in FIG. 8, the example system 800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one implementation, the central computing device may be a cloud of one or more server computers that are connected to the multiple devices through a network, the Internet, or other data communication link.

In one implementation, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one implementation, a class of target devices is created, and experiences are tailored to the generic class of devices. A class of devices may be defined by physical features, types of usage, or other common characteristics of the devices.

In various implementations, the computing device 802 may assume a variety of different configurations, such as for computer 814, mobile 816, and television 818 uses. Each of these configurations includes devices that may have generally different constructs and capabilities, and thus the computing device 802 may be configured according to one or more of the different device classes. For instance, the computing device 802 may be implemented as the computer 814 class of a device that includes a personal computer, desktop computer, multi-screen computer, laptop computer, netbook, and so on.

The computing device 802 may also be implemented as the mobile 816 class of device that includes mobile devices, such as a mobile phone, portable music player, portable gaming device, a tablet computer, a multi-screen computer, and so on. The computing device 802 may also be implemented as the television 818 class of device that includes devices having or connected to generally larger screens in casual viewing environments. These devices include televisions, set-top boxes, gaming consoles, and so on.

The techniques described herein may be supported by these various configurations of the computing device 802 and are not limited to the specific examples of the techniques described herein. This is illustrated through the inclusion of the query generation and result rendering application 105 on the computing device 802. The functionality represented by the query generation and result rendering application 105 and other modules/applications may also be implemented all or in part through the use of a distributed system, such as over a “cloud” 820 via a platform 822 as described below.

The cloud 820 includes and/or is representative of a platform 822 for resources 824. The platform 822 abstracts the underlying functionality of hardware (e.g., servers) and software resources of the cloud 820. The resources 824 may include applications and/or data that can be utilized while computer processing is executed on servers that are remote from the computing device 802. Resources 824 can also include services provided over the Internet and/or through a subscriber network, such as a cellular or Wi-Fi network.

The platform 822 may abstract resources and functions to connect the computing device 802 with other computing devices. The platform 822 may also serve to abstract scaling of resources to provide a corresponding level of scale to encountered demand for the resources 824 that are implemented via the platform 822. Accordingly, in an interconnected device implementation, the implementation of functionality described herein may be distributed throughout the system 800. For example, the functionality may be implemented in part on the computing device 802 as well as via the platform 822 which abstracts the functionality of the cloud 820.

Although the techniques have been described in language specific to structural features and/or methodological acts, it is to be understood that the subject matter defined in the appended claims is not necessarily limited to the specific features or acts described. Rather, the specific features and acts are disclosed as example forms of implementing the claimed subject matter, and other equivalent features and methods are intended to be within the scope of the appended claims.

Further, various different implementations are described, and it is to be appreciated that each described implementation can be implemented independently or in connection with one or more other described implementations.

What is claimed is:

1. A system for handling a user query, the system comprising:
a processor; and
a memory, coupled to the processor, configured to store executable instructions that, when executed by the processor, cause the processor to:
set up a symbol or link in a user interface, the symbol or link representing a dataset in a cloud environment;
receive a user query initiated by a user through the user interface;
parse the dataset to identify a data file associated with the user query;
generate a sequence of queries based on the user query and content parsed from the data file; and
search against the data file using the sequence of queries to obtain a set of query results.

2. The system of claim 1, wherein the executable instructions further include instructions that, when executed by the processor, cause the processor to:
render the query results in the user interface according to a predefined visualization format.

3. The system of claim 1, wherein the executable instructions further include instructions that, when executed by the processor, cause the processor to:
perform a data analysis on the query results; and
render the data analysis in the user interface according to a predefined visualization format.

4. The system of claim 1, wherein the executable instructions further include instructions that, when executed by the processor, cause the processor to:
if the user query is broad, generate an additional sequence of queries; and
search against the data file using the additional sequence of queries to obtain an additional set of query results.

5. The system of claim 1, wherein the dataset includes one or more data files, and the data file associated with the user query is identified from the one or more data files based on contextual information identified from the user query and the content parsed from the data file.

6. The system of claim 1, wherein, to generate the sequence of quires, the executable instructions further include instructions that, when executed by the processor, cause the processor to:
specify a data service provider;
define one or more rules and instructions for generating the sequence of queries specific to the database service provider; and
create the sequence of queries following the one or more rules and instructions.

7. The system of claim 6, wherein the data service provider is an SQL-compatible database service provider.

8. The system of claim 7, wherein the generated sequence of queries are SQL statements.

9. The system of claim 1, wherein, to generate the sequence of quires, the executable instructions further include instructions that, when executed by the processor, cause the processor to:
determine whether the user query and a column in the data file indicate an existence of sentimental analysis;
if there is an existence of sentimental analysis, determine whether there is a classification column in the data file associated with the user query; and
if there is no classification column associated with the user query, create a list of classifications and use a text classification model to create a temporary column for the data file and insert classification keywords into the temporary column; and
generate the sequence of queries including the classification keywords.

10. The system of claim 1, wherein the executable instructions further include instructions that, when executed by the processor, cause the processor to:
if parsing the dataset does not lead to an identification of a data file associated with the user query, return an error message in response to the user query.

11. The system of claim 1, wherein the sequence of queries are generated by a machine learning model.

12. The system of claim 11, wherein the machine learning model is a large language model.

13. The system of claim 2, wherein the user interface is a part of a drawing and art design application that includes a set of text tools and drawing tools for generating one or more text and non-text objects.

14. The system of claim 13, wherein the executable instructions further include instructions that, when executed by the processor, cause the processor to:
render the query results in one or more of a text or non-text object.

15. The system of claim 13, wherein the one or more of a text or non-text object comprise one or more of a template, diagram, flow chart, or wireframe.

16. A method for handling a user query, comprising:
setting up a symbol or link in a user interface, the symbol or link representing a dataset in a cloud environment;
receiving a user query initiated by a user through the user interface;
parsing the dataset to identify a data file associated with the user query;
generating a sequence of queries based on the user query and content parsed from the data file; and
searching against the data file using the sequence of queries to obtain a set of query results.

17. The method of claim 16, further comprising:
rendering the query results in the user interface according to a predefined visualization format.

18. The method of claim 16, further comprising:
performing a data analysis on the query results; and
rendering the data analysis in the user interface according to a predefined visualization format.

19. The method of claim 16, further comprising:
if the user query is broad, generating an additional sequence of queries; and
searching against the data file using the additional sequence of queries to obtain an additional set of query results.

20. The method of claim 16, wherein generating the sequence of queries further comprises:
if parsing the dataset does not lead to an identification of a data file associated with the user query, returning an error message in response to the user query.
